(19) United States
(12) Patent Application Publication
(10) Pub. No.: US 2006/0249572 A1
(43) Pub. Date: Nov. 9, 2006

(54) Electronic transaction system capable of improving transaction security and electronic transaction method thereof

(76) Inventors: Gigi Chen, Taipei (TW); Ko Li Chao, Taipei (TW); Kuo Sen Hsueh, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/168,520

(22) Filed: Jun. 29, 2005

(30) Foreign Application Priority Data
May 3, 2005 (TW) 094114292

(51) Int. Cl. G06K 5/00; G06Q 99/00

(52) U.S. Cl. 235/380; 705/64

(57) ABSTRACT

An electronic transaction system and an electronic transaction method thereof mainly comprise at least one issuing unit to generate at least one electronic certificate capable of representing the issuing unit or transaction object and at least one personal radio frequency identification capable of representing corresponding users according to the demanding application. The applying data associated with users can be stored in a certified management unit, wherein the electronic certificate can be stored in a portable electronic device owned by the user and displayed in the display screen of the portable electronic device. The personal radio frequency identification can also be kept by the user. When the user wants to proceed a shopping transaction, a sale end operation device of a sale end reads the electronic certificate and personal radio frequency identification, respectively, and connects to the certified management unit via a telecommunication device. The certified management unit determines and decides whether to permit proceeding a follow-up transaction or completing the shopping transaction according to the electronic certificate, personal radio frequency identification, and applying data. This way, not only the security and convenience in electronic transaction can be improved, but also the users have privacy.

### FIELD OF THE INVENTION

The present invention is related to an electronic transaction system and an electronic transaction method thereof which not only improve the security and convenience in electronic transaction, but also promise the users have privacy.

### BACKGROUND

By the increasing development of the society and financial industry, the number of credit transaction can be called a new force suddenly coming to the fore. In various credit transactions, the consuming mode using plastic money, such as credit card, etc., is widely adopted by general consumers due to its convenience and has become main transaction mode in daily shopping products.

The prior art payment method of credit card is shown in FIG. 1. The main transaction steps comprise:

Step 101 and step 112: the user must apply a credit card capable of representing the user to at least one issuing unit, such as bank, financial organization or store. The applying data (personal data) of the user is stored in a certified management unit (or financial information center), and the user can keep the credit card;

Step 103: when the user wants to proceed a shopping transaction, the personal owned credit card is given to a sale end (store), and the sale end uses a card reader to input consuming data, such as consuming amount of money, etc.;

Step 105: place the credit into the card reader to proceed the card sliding operation to read the credit card data;

Step 107: the card reader transmits transaction data, such as the credit card data, consuming amount of money, card reader number (i.e. sale end number), and card reading time, etc., to the certified management unit, and the certified management unit compares the credit card data with the stored applying data. If the data is correct after comparison, an authorization code is obtained;

Step 109: after the sale end gets the authorization code, the credit card receipt (or payment receipt) is printed out, and the user signs it and exchanges shopped products to complete the transaction of the shopped products.

The previous mentioned prior are shopping method of credit card has been accepted by consumers and widely used in general credit card transaction occasions. Nevertheless, in the previous mentioned shopping method, the user's credit card has to be placed in the card reader of the sale end to proceed the card reading operation and read credit card data. In this process, it is very possible to cause the credit card data recorded or stolen by unworthy personages, and further fake card is made to proceed to embezzle. It causes not only shopping dispute easily, but also the issuing bank or user losing money or damaging goodwill. Further, when the user forgets to carry a wallet or credit cards, an awkward situation of unable to pay is often caused too.

Therefore, seeking for another easier and safer electronic transaction mode is always expected by all financial industries and consumers. Besides, since portable electronic devices, such as cell phones, are common in use and have portability, it is treated as one of the options by industries. However, although the portable electronic devices, such as cell phones, have portability, the security, speed, and personal identify identification in use is doubted by the masses. Therefore, the technology of using cell phones as a product transaction media is still needed to be developed.

Additionally, a technology of a cell phone attached with radio frequency identification (RFID) appeared in market. It mainly uses the identification speed of RFID to improve the identification of cell phones with which other functions besides product consuming can be proceeded. However, the existed technology of cell phones attached with radio frequency identification is placing the RFID on the cell phone mother board or subscriber identity module (SIM card) which is generally controlled and issued by cell phone manufacturer or telecommunication industries. For financial organizations or general stores, they do not have much autonomy, and thus the motive power to push into the market is lacked.

Further, since RFID is directly set on the cell phone mother board or SIM card, if RFID on the cell phone wants to be changed or replaced after use, not only the procedures are very troublesome, but also the third party can use improper wireless radio frequency to easily scan to know the existence position of the user of RFID content due to this structure. Therefore, it is a big danger for the security and privacy of consumers in other occasions.

### SUMMARY OF THE INVENTION

Accordingly, how to design a novel electronic transaction system and an electronic transaction thereof with respect to the previous mentioned shortcomings of the prior art is the key point of the present invention. Not only the risk of credit card being embezzled can be avoided, but also security, speed, and privacy is concerned. Therefore,

It is a primary object of the present invention to provide an electronic transaction system using widely used portable electronic device to store electronic certificates capable of representing financial organizations or stores and collocating with personal radio frequency identification capable of representing individuals to proceed shopping or electronic transaction. This way, the security and convenience of electronic transaction can be improved.

It is a secondary object of the present invention to provide an electronic transaction system whose personal radio frequency identification can be owned by the user and carried separately from the cell phone. This way, the privacy of the user in various occasions can be improved.

It is another object of the present invention to provide an electronic transaction system whose personal radio frequency identification and electronic certificate can both be independently issued by financial organizations, government organizations, or stores without limiting by the cell phone manufacturer or telecommunication industry to totally meet existing standard mode of consuming habits and consuming laws. This way, the popularization in use in market can be improved.

It is another object of the present invention to provide an electronic transaction system using quick and convenient telecommunication device to receive different electronic certificates anytime. It is convenient for users to respond to the needs in various occasions to complete various transactions or product exchange.

It is another object of the present invention to provide an electronic transaction method using widely used portable electronic devices to store electronic certificates capable of representing financial organization or stores and collocating personal radio frequency identification capable of representing individuals to proceed shopping or electronic transactions. This way, not only the transaction security, convenience, and privacy of electronic transactions can be improved, but also it is beneficial to popularize in market.

To achieve the previous mentioned objects, the present invention provides an electronic transaction system capable of improving transaction security mainly comprising: at least one issuing unit to selectively generate one of at least one electronic certificate, at least one personal radio frequency identification, and a combination thereof according to at least one demand of a user, and the user being able to keep the personal radio frequency identification; a portable electronic device capable of storing the electronic certificate; and a sale end operation device fixed with an electronic certificate reader for reading the electronic certificate and a radio frequency signal reader for reading the personal radio frequency identification and for deciding whether to proceed a follow-up transaction operation according to read electronic certificate and personal radio frequency identification.

Further, to achieve the previous mentioned objects, the present invention further provides an electronic transaction system capable of improving transaction security mainly comprising: an issuing unit to generate an electronic certificate according to at least one demand of a user; at least one portable electronic device capable of receiving the electronic certificate via a telecommunication device; and a sale end operation device fixed with an electronic certificate reader for reading the electronic certificate and for deciding whether to proceed a follow-up transaction operation according to read electronic certificate.

Further, to achieve the previous mentioned objects, the present invention further provides an electronic transaction method capable of improving transaction security mainly comprising the steps of: a user applying a demanding application to an issuing unit such that the issuing unit can selectively generate one of at least one electronic certificate, at least one personal radio frequency identification, and a combination thereof, and applying data associated with the electronic certificate and the personal radio frequency identification is stored in a certified management unit; the user keeping the personal radio frequency identification and using a portable electronic device to store the electronic certificate; a sale end operation device capable of reading the electronic certificate and the personal radio frequency identification when a shopping transaction wants to be proceeded; and connecting to the certified management unit and transmitting the electronic certificate and the personal radio frequency identification to the certified management unit, and the certified management unit deciding whether to proceed a follow-up transaction operation according to the electronic certificate, personal radio frequency identification, and applying data.

### BRIEF DESCRIPTION OF DRAWINGS

FIG. 1 is a flow chart of the transaction in a prior art credit card transaction system.

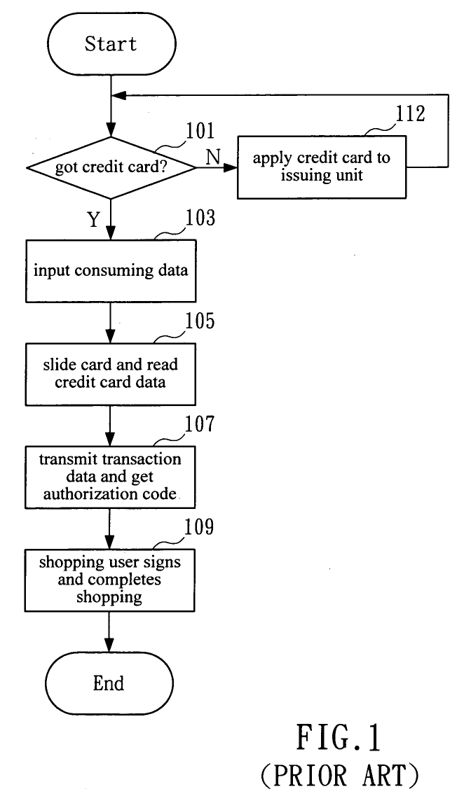

FIG. 2 is a structural diagram of a preferred embodiment of an electronic transaction system of the present invention.

FIG. 3 is a flow chart of the transaction of a preferred embodiment of the electronic transaction system of the present invention.

FIG. 4 is a structural diagram of an alternate embodiment of an electronic transaction system of the present invention.

FIG. 5 is a flow chart of the transaction of an alternate embodiment of an electronic transaction system of the present invention.

FIG. 6 is a structural diagram of an alternate embodiment of an electronic transaction system of the present invention.

### DETAILED DESCRIPTION

The structural features and the effects to be achieved may further be understood and appreciated by reference to the presently preferred embodiments together with the detailed description.

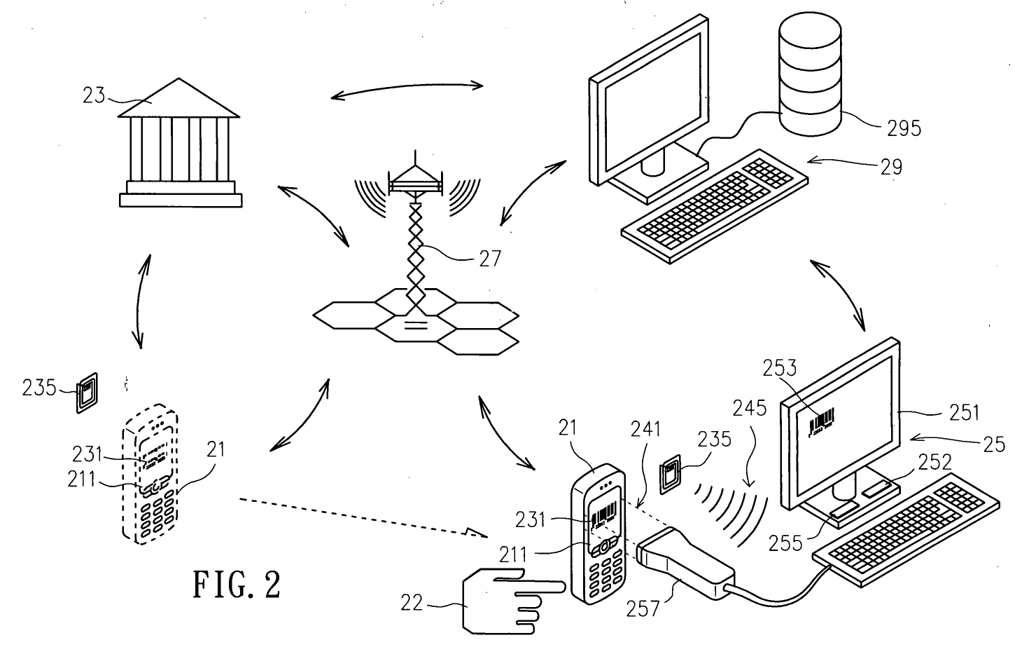

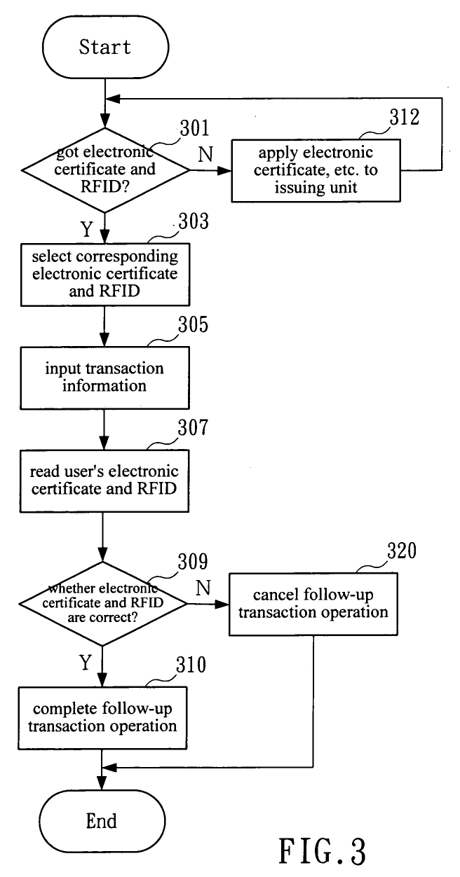

Firstly, refer to FIG. 2 together with FIG. 3, respectively a structural diagram and flow chart of a preferred embodiment of an electronic transaction system of the present invention. As shown, the electronic transaction system mainly comprises at least one issuing unit 23, at least one portable electronic device 21, at least one sale end operation device 25, and a certified management unit 29. Therein, the issuing unit 23, such as bank, financial organization, government organization, community organization, or store, can accept the application of at least one user 22 to selectively make or generate at least one electronic certificate 231, at least one personal radio frequency identification (RFID) 235, or a combination of the electronic certificate 231 and personal radio frequency identification 235. The applying data 295 associated with the electronic certificate 231 and personal radio frequency identification 235 can be transmitted directly or via a telecommunication device 27 to be stored in the certified management unit 29, as shown in step 301 and step 312.

Among them, the electronic certificate 231 can be used to represent the issuing unit 23 or to represent shopping certificate of shopped products or service which can comprise at least the data of the issuing unit or connection data with the certified management unit 29, and the electronic certificate can be directly or via the telecommunication device 27, such as GSM system, CDMA system, DAMPS system, FLEX system, CDPD system, PDC system, CT2 system, DECT system, PACS system, PHS system, GPRS system, or physical network, sent to the portable electronic device 21 to be stored therein and shown on the display screen 211 thereof. Therefore, the electronic certificate 231 can be shown as a barcode, MMS, SMS, WAP pull/push, symbol, or number. Further, the personal radio frequency identification 235 can represent individual of the user which can comprise at least personal data of the user or the connection data with the certified management unit.

When the user wants to proceed a shopping transaction, he/she can select and hold the personal radio frequency identification 235 issued by one of the issuing unit 23 and collocate with corresponding electronic certificate 231 stored in the portable electronic device 21, as shown in step 303.

When the user completes picking out and buying products and wants to pay up and charge on credit card, a sale end (store) uses a sale end operation device 25 to complete the electronic transaction. As with the prior art transaction mode, the sale end also inputs transaction information, such as transaction amount of money, product name, or quantity, into the sale end operation device 25, as shown in step 305.

The sale end operation device 25 of the sale end can comprise a display 251, an electronic certificate reader 257, and a radio frequency signal reader 257. Among them, the electronic certificate reader 257 can read the electronic certificate 231 in the portable electronic device 21 via an infrared rays signal or optical signal 241, while the radio frequency signal reader 257 uses a radio frequency signal 245 to read the personal radio frequency identification 235 hold by the user, as shown in step 307.

The read input electronic certificate 231 can be shown directly on the display 251 of the sale end operation device 25 to provide the sale end a simple determination and cue. For example, prompting which bank issued the electronic certificate 231 hold by the user? Whether the valid date is correct? Or whether there is another matter needing attention?

Again, after the sale end operation device 25 reads data on the electronic certificate 231 and personal radio frequency identification 235, it can determine whether the read electronic certificate 231 matches with the personal radio frequency identification 235 by itself. If not, then stop the follow-up transaction. Of course, after reading the electronic certificate 231 or the personal radio frequency identification 235, the sale end operation device 25 can connect to the certified management unit 29 via a telecommunication device 27 according to the read data, and the certified management unit 29 compares the received the electronic certificate 231 and the personal radio frequency identification 235 with the applying data 295 stored therein to determine whether the hold electronic certificate 231 and personal radio frequency identification 235 is correct, as shown in step 309.

If the read electronic certificate 231 and personal radio frequency identification 235 matches with each other in the comparing process, and the electronic certificate 231 and personal radio frequency identification 235 was not notified to be stopped or cancelled, it means legally using. The next follow-up transaction operation should be able to be continued proceeding. For example, input transaction amount of money, input sale end number 252, grant products, grant transaction certificate, or cancel transaction, etc., as shown in step 310.

Of course, if in the comparing process, the read electronic certificate 231 and personal radio frequency identification 235 was found out unmatched with each other, or one of the electronic certificate 231 and personal radio frequency identification 235 were notified to be stopped or cancelled, then immediately stop the follow-up transaction operation, as shown in step 320.

Since the present invention uses the issuing unit 23 to issue the electronic certificate 231 and personal radio frequency identification 235, it is the same as the current credit card issuing unit and step without limited in having to tie in the cell phone manufacturer or telecommunication industry. Therefore, there is no problem in popularizing in market or acceptability. Besides, since the personal radio frequency identification 235 of the present invention can be separated from the portable electronic device 21, when the user does not expect to shop and consume, it does not need to be carried around or fixed on the portable electronic device 21, and thus prevent the third party from knowing the user's location by an illegitimate scanning way to maintain the privacy of the user.

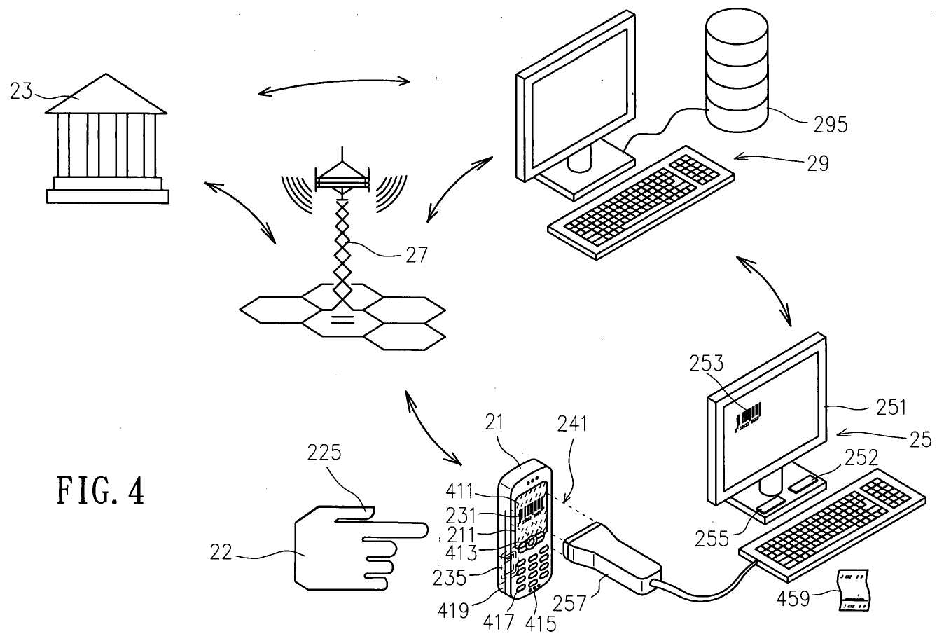

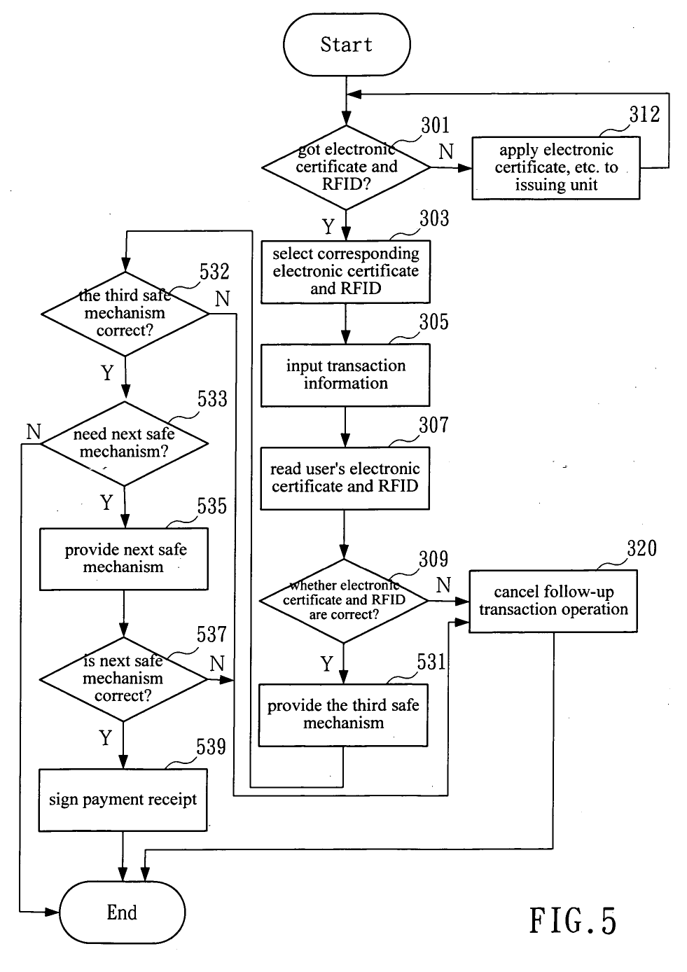

Moreover, please refer FIG. 4 and FIG. 5 simultaneously, respectively a structural diagram and flow chart of transactions of an alternate embodiment of the present invention. As shown, in the embodiment, when the shopping transaction amount of money of the user is more than a predetermined value, or the issuing unit 23 has a safe need, the electronic transaction mode of the present invention can add more follow-up transaction operations besides the same steps 301˜step 309 in the previous mentioned embodiment.

For example, the issuing management 29 or sale end operation device 25 can provide reasons of the transaction amount of money or transaction security to continue asking the user to provide another safe mechanism (the third safe mechanism). For example, ask the user to push the symbol key 417 on the sale end operation device 25 or the portable electronic device 21 to obtain a valid symbol consisted of numbers, letters, or symbols, as shown in step 531.

The valid symbol can be transmitted to the certified management unit 29 via the telecommunication device 27 and compared with the applying data 295 pre-stored in the certified management unit to determine whether the input valid symbol is correct, as shown in step 532. If correct, then continue proceeding step 533. If incorrect, then proceed step 320 to cancel the transaction shopping.

The certified management unit 29 or sale end operation device 25 can further provide reasons of the transaction amount of money or transaction security to continue asking the user to provide another safe mechanism. For example, a biological feature capturer on the sale end operation device 25 or the portable electronic device 21, such as image capture (camera lens) 413 or voice capturer (microphone) 415, can be used to capture biological feature signal 225 capable of representing individual of the user 22, such as the fingerprint, pupil, blood vessel, or voice, etc. of the user, as shown in step 535.

In an alternate embodiment, the symbol, number, letter, or valid symbol input by the user 22 can be treated as one of the biological feature signal 225.

The biological feature signal 225 captured by the sale end operation device 25 or portable electronic device 21 can be transmitted to the certified management unit 295 and compared with the applying data 295 pre-stored in the certified management unit to determine whether the input biological feature signal 225 is correct, as shown in step 537. If correct, then continue proceeding the step 539. If incorrect, then proceed step 320 to cancel the transaction shopping.

After using the sale end operation device 25 or portable electronic device 21 to simply and conveniently proceed several safe mechanisms, if all correct, then it means the electronic certificate 253 and personal radio frequency identification 235 hold by the user 22 is correct. Therefore, as with the credit card transaction mode, the sale end operation device 25 can also get an authorization code and output a payment receipt 459 or a transaction certificate. Optionally, the user 22 can be requested to sign to be beneficial checking, as shown in step 539.

Again, the follow-up transaction operations of the previous mentioned embodiment can comprise one of step 305, step 310, step 320, or step 531˜step 539 shown in the embodiment.

Besides, since the electronic certificate 231 of the present invention can be used to represent the issuing unit 23, and each user 22 or each portable electronic device 21 can store a plurality of electronic certificates 231. However, sometimes the multiple -electronic certificates 231 are hard to be determined to represent which issuing unit 23 in a short time, or which personal radio frequency identification 235 should it be collocated with. Therefore, the display screen 211 of the portable electronic device 21 of the present invention can also comprise a colorful image 411. Each colorful image 411 can comprise different electronic certificates 21 to easily determine the electronic certificate 231 to be adopted.

Although the personal radio frequency identification (RFID) 235 of the present invention can be issued by the issuing unit 23 by itself and can be separated from the portable electronic device 21 anytime to be beneficial to popularizing in market, usage security, convenience, and privacy. However, for carrying convenience, the personal radio frequency identification 235 can also be selected to fix or place in the portable electronic device 21, such as pasting inside of the battery cover 419, on the outer housing of the portable electronic device 21, or hanging on the portable electronic device 21 to become a hanging decoration, to prevent from the awkward situation of not carrying the personal radio frequency identification 235 thus unable to consume.

In different embodiments of the present invention, the personal radio frequency identification 235 can also be directly fixed on the mother board or subscriber identity module (SIM card) in the portable electronic device 21. Although such structure exists the risk of losing user's privacy, the above mentioned object of product transaction can also be achieved by the double certification mode of the personal radio frequency identification 235 and electronic certificate 231. The personal radio frequency identification 235 can also be produced by cell phone industry authorized by general stores, or bought and used by the stores after the cell phone industry produced, the above mentioned object of product transaction can also be achieved.

Again, in an alternate embodiment of the present invention, if the electronic certificate 231 and personal radio frequency identification 235 are issued by single store, and there is no business platform capable of transacting crossing different stores, the issuing unit 23 or certified management unit 29 of the previous mentioned embodiment can directly be the sale end operation device 25. All the previous mentioned comparing work of safe mechanism can be accomplished in the sale end operation device 25.

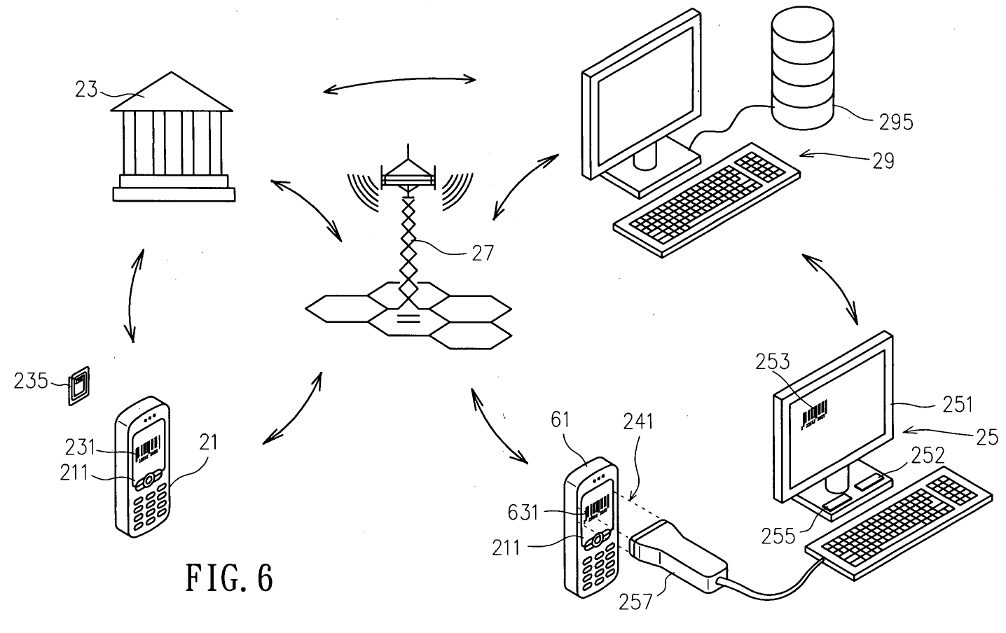

Finally, please refer to FIG. 6, a structural diagram of an alternate embodiment of the present invention. As shown, in this embodiment, the issuing unit 23 can generate only electronic certificate 231, only personal radio frequency identification 235, or both of electronic certificate 231 and personal radio frequency identification 235 according to need. The electronic certificate 231 can represent a shopping certificate, bus or train ticket, flight ticket, ticket, concert ticket, preferential price ticket, issuing unit, exchange certificate, or a transaction object, etc., which can be selectively stored in the portable electronic device 21 of the shopping user. The shopping user can notify the issuing unit 23 to cancel or transform the electronic certificate 231 in response to real need. As an example of transforming the number of showings of a concert of the ticket, the issuing unit 23 selects to void or alter the electronic certificate 231 after ensuring the user's need, and the altered electronic certificate 231 can be re-transmitted to the portable electronic device 21 via the telecommunication device 27.

Again, the user can also request the issuing unit 23 to directly transmit the electronic certificate 231 to another portable electronic device 61 to become the electronic certificate 631 of the owner of the portable electronic device 61 to exchange bought products or service. In one of the embodiment, the owner of the portable electronic device 61 can directly exchange products or service according to the electronic certificate 631. However, in an alternate embodiment, the owner of the portable electronic device 61 must have his/her personal radio frequency identification (235) besides having the electronic certificate 631 to exchange products or service by the way of double certification. The issuing unit 23 can be informed of basic information in the personal radio frequency identification (235) when the previous user notifies to transform the electronic certificate 231.

Again, the issuing unit 23 can widely issue the electronic certificates 231, 631 to a plurality of portable devices 21, 61, and the member or user having corresponding personal radio frequency identification 235 can use the received electronic certificates 231, 631 and personal radio frequency identification 235, or only electronic certificates 231, 631 to exchange products or service to save notification resource and processing time needed by general companies in informing members to go and get products.

Of course, the previous mentioned portable electronic device 21, 61 can be spoken without specific reference to electronic devices, such as cell phone, portable computer, personal digital assistant, stock messenger, global satellite locator, video/audio player, or recording pen.

In summary, it is appreciated that the present invention is related to an electronic transaction system and an electronic transaction method thereof which not only the security and convenience in electronic transaction can be improved, but also the users have privacy. Therefore, the present invention should be granted a patent.

The foregoing description is merely one embodiment of present invention and not considered as restrictive. All equivalent variations and modifications in process, method, feature, and spirit in accordance with the appended claims may be made without in any way from the scope of the invention.

### LIST OF REFERENCE SYMBOLS

21 portable electronic device
211 display screen
22 user
225 biological feature signal
23 issuing unit
231 electronic certificate
235 personal radio frequency identification
241 optical signal
245 radio frequency signal
25 sale end operation device
251 display
252 sale end number
253 electronic certificate
255 radio frequency signal reader
257 electronic certificate reader
27 telecommunication device
29 certified management unit
295 applying data
411 colorful image
413 image capturer
415 voice capturer
417 symbol key
419 battery cover
459 payment receipt
61 portable electronic device
631 electronic certificate

1. An electronic transaction system capable of improving transaction security,
mainly comprising:
at least one issuing unit to selectively generate one of at least one electronic certificate, at least one personal radio frequency identification, and a combination thereof according to at least one demand of a user, and the user being able to keep said personal radio frequency identification;
a portable electronic device capable of storing said electronic certificate; and
a sale end operation device fixed with an electronic certificate reader for reading said electronic certificate and a radio frequency signal reader for reading said personal radio frequency identification and for deciding whether to proceed a follow-up transaction operation according to read electronic certificate and personal radio frequency identification.

2. The electronic transaction system according to claim 1, wherein each personal radio frequency identification can represent a corresponding user, and said electronic certificate can selectively represent one of said issuing unit and at least one transaction object.

3. The electronic transaction system according to claim 1 further comprising a certified management unit, and said portable electronic device and said sale end operation device capable of connecting to said certified management unit via a telecommunication device, respectively.

4. The electronic transaction system according to claim 1, wherein said electronic certificate can be selected from one of a barcode, multimedia message, text message, wireless network collecting message, symbol, and number.

5. The electronic transaction system according to claim 1, wherein said issuing unit can be selected from one of a financial institution, store, government organization, and community organization.

6. The electronic transaction system according to claim 1 further comprising at least one biological feature capturer selectively fixed at one of said portable electronic device and said sale end operation device and for inputting at least one biological feature signal of said user.

7. The electronic transaction system according to claim 6, wherein said biological feature capturer can be selected from one of an image capturer, voice capturer, and symbol key.

8. The electronic transaction system according to claim 6, wherein said biological feature signal can be selected from one of a fingerprint, pupil, blood vessel, voice, symbol, number, letter, and valid symbol.

9. The electronic transaction system according to claim 6, wherein said biological feature signal can be transmitted to a certified management unit, and said certified management unit can use it to decide whether to proceed said follow-up transaction operation.

10. The electronic transaction system according to claim 1, wherein said follow-up transaction operation can be selected from one of inputting transaction amount of money, connecting a certified management unit, inputting a sale end number, inputting a biological feature signal, printing payment receipt, granting products, granting transaction certificate, and canceling transaction.

11. The electronic transaction system according to claim 1, wherein said personal radio frequency identification can be selected from one of fixed in said portable electronic device and separated from portable electronic device.

12. The electronic transaction system according to claim 1, wherein said portable electronic device further comprises a display screen capable of displaying said electronic certificate.

13. The electronic transaction system according to claim 12, wherein said display screen can use a colorful image to represent one of said corresponding issuing units.

14. The electronic transaction system according to claim 1, wherein said issuing unit uses a telecommunication device to transmit said electronic certificate to said portable electronic device.

15. The electronic transaction system according to claim 1, wherein said portable electronic device can be selected from one of a cell phone, portable computer, personal digital assistant, stock messenger, global satellite locator, video/audio player, and recording pen.

16. The electronic transaction system according to claim 1, wherein said radio frequency signal reader can be directly fixed in said electronic certificate reader.

17. An electronic transaction system capable of improving transaction security,
mainly comprising:
an issuing unit to generate an electronic certificate according to at least one demand of a user;
at least one portable electronic device capable of receiving said electronic certificate via a telecommunication device; and
a sale end operation device fixed with an electronic certificate reader for reading said electronic certificate and for deciding whether to proceed a follow-up transaction operation according to read electronic certificate.

18. The electronic transaction system according to claim 17, wherein said electronic certificate can be selected from one of a barcode, multimedia message, text message, wireless network collecting message, symbol, and number.

19. The electronic transaction system according to claim 17, wherein said electronic certificate can be selected from one of a shopping certificate, bus or train ticket, flight ticket, vote, concert ticket, preferential price ticket, issuing unit, exchange certificate, and transaction object.

20. An electronic transaction method capable of improving transaction security,
mainly comprising the steps of:
a user applying a demanding application to an issuing unit such that said issuing unit can selectively generate one of at least one electronic certificate, at least one personal radio frequency identification, and a combination thereof, and applying data associated with said electronic certificate and said personal radio frequency identification stored in a certified management unit;
the user keeping said personal radio frequency identification and using a portable electronic device to store said electronic certificate;
a sale end operation device capable of reading said electronic certificate and said personal radio frequency identification when a shopping transaction wants to be proceeded; and
connecting to said certified management unit and transmitting said electronic certificate and said personal radio frequency identification to said certified management unit, and said certified management unit deciding whether to proceed a follow-up transaction operation according to said electronic certificate, personal radio frequency identification, and applying data.

21. The electronic transaction method according to claim 20, wherein said issuing unit can be selected from one of a financial institution, store, government organization, and community organization.

22. The electronic transaction method according to claim 20, wherein said follow-up transaction operation can be selected from one of inputting transaction amount of money, inputting a sale end number, requesting to input a biological feature signal, granting products, granting transaction certificate, and canceling transaction.

23. The electronic transaction method according to claim 20 further comprising the steps of:
requesting to input a biological feature signal;
the user capable of selecting one of said portable electronic device and said sale end operation device to input said user's biological feature signal and using a telecommunication device to transmit to said certified management unit.

24. The electronic transaction method according to claim 23, wherein said biological feature signal can be selected from one of a fingerprint, pupil, blood vessel, voice, symbol, number, letter, and valid symbol.

25. The electronic transaction method according to claim 20 further comprising the step of:
placing at least one personal radio frequency identification into said portable electronic device.

26. The electronic transaction method according to claim 20, wherein said portable electronic device can be selected from one of a cell phone, portable computer, personal digital assistant, stock messenger, global satellite locator, video/audio player, and recording pen.

27. The electronic transaction method according to claim 20, wherein said electronic certificate can be selected from one of a barcode, multimedia message, text message, wireless network collecting message, symbol, and number.

28. The electronic transaction method according to claim 20, wherein said portable electronic device further comprises a display screen capable of displaying said electronic certificate.

29. The electronic transaction method according to claim 28, wherein said display screen can present a colorful image to represent one of said corresponding issuing units.

30. The electronic transaction method according to claim 20 further comprising the step of:
said sale end operation device selecting to print out one of a payment receipt and a transaction certificate and requesting the user to sign.

31. The electronic transaction method according to claim 20 further comprising the step of:
the user notifying said issuing unit and requesting said electronic identification to be transmitted to another portable electronic device through a telecommunication device.

32. The electronic transaction method according to claim 31 further comprising the step of:
said sale end operation device only reading said electronic identification and deciding whether to proceed said follow-up transaction operation according to said electronic identification.
